(19) United States
(12) Patent Application Publication
(10) Pub. No.: US 2009/0100195 A1
(43) Pub. Date: Apr. 16, 2009

(54) Methods and Apparatus for Autonomic Compression Level Selection for Backup Environments

(76) Inventors: Eric L. Barsness, Pine Island, MN (US); John M. Santosuosso, Rochester, MN (US)

Correspondence Address: IBM Corporation,;Matthew Zehrer, Intellectual Property Law Dept. 917, 3605 Hwy. 52 North, Rochester, MN, 55901, US

(21) Appl. No.: 11/870,737

(22) Filed: Oct. 11, 2007

(51) Int. Cl. G06F 15/16; G06F 17/30

(52) U.S. Cl. 709/247; 707/101; 707/E17.002

(57) ABSTRACT

In one aspect, a method is provided. The method includes: (1) gathering statistics during compression of a dataset into a compressed dataset and during transfer of the compressed dataset over a network connection; and (2) optimizing compression settings based on the gathered statistics.

### FIELD OF THE INVENTION

The present invention relates generally to backup environments and, more particularly, to methods and apparatus for autonomic compression level selection for backup environments.

### BACKGROUND

Backup environments may enable backup of computer data, such as datasets (e.g., file libraries). A backup environment may include, for example, a server and a backup server connected via a network connection (e.g., one or more connections between the server and the backup server). A dataset may be transmitted from the server to the backup server over the network connection. The dataset may be compressed into a compressed dataset by the server, for example, and the compressed dataset may be transmitted to the backup server over the network connection.

### SUMMARY OF THE INVENTION

In a first aspect of the invention, a method may be provided. The method may include: (1) gathering statistics during compression of a dataset into a compressed dataset and during transfer of the compressed dataset over a network connection; and (2) optimizing compression settings based on the gathered statistics.

In a second aspect of the invention, a device may be provided. The device may include: (1) a server; and (2) logic, coupled to the server, and to: (a) gather statistics during compression of a dataset into a compressed dataset and during transfer of the compressed dataset over a network connection; and (b) optimize compression settings based on the gathered statistics.

In a third aspect of the invention, a system may be provided. The system may include: (1) a server; (2) a backup server; and (3) logic, coupled to at least one of the server and the backup server, and to: (a) gather statistics during compression of a dataset into a compressed dataset and during transfer of the compressed dataset over a network connection from the server to the backup server; and (b) optimize compression settings based on the gathered statistics.

Other features and aspects of the present invention will become more fully apparent from the following detailed description, the appended claims and the accompanying drawings.

### BRIEF DESCRIPTION OF THE FIGURES

FIG. 1A is a block diagram of an exemplary backup environment in which the present methods and apparatus may be implemented;

FIG. 1B is a schematic representation of exemplary compression ratios, compression rates, transfer rates, and compression CPU usages for multiple datasets, such as the datasets 104 of FIG. 1A;

FIG. 1C is a schematic representation of a backup window for a backup process;

FIG. 2 illustrates an exemplary method for gathering compression ratios, compression rates, transfer rates, and compression CPU usages for multiple datasets, such as the datasets 104 of FIG. 1A;

FIG. 3 illustrates an exemplary method for determining whether to compress datasets, such as the datasets 104 of FIG. 1A;

FIG. 4 illustrates an exemplary method of operation 314 of FIG. 3; and

FIG. 5 illustrates an exemplary method for determining whether to compress datasets, such as the datasets 104 of FIG. 1A, to be stored on a tape storage.

### DETAILED DESCRIPTION

A bottleneck in a backup environment including a network connection may be the speed at which datasets may be transferred over the network connection. The time it takes to transfer information, i.e. raw bytes, across the network connection may be dependent upon many factors including the speed of any Ethernet cards and switches, the number of any switches, frame size, and network traffic. Ultimately though, a maximum throughput may be determined regardless of any performance tuning parameters that may be involved. Since a size of a dataset to be backed-up may be significant (tens to hundreds of gigabytes (GB) or more of data per dataset), network send time may be significant. Additionally, many datasets from many systems may need to save concurrently in the same backup environment. Thus the total amount of information to be transferred may be significant, and in some cases, may require more time than is available in a backup window. Such a result may interfere with other system activities.

Another bottleneck in a backup environment including a server may be the amount of time it may take to process datasets into compressed datasets. Multiple levels of compression (e.g., low, medium, and high) may be available. Higher compression may result in significantly more compression CPU usage during processing, however a much higher level of compression may be achieved.

These two bottlenecks may create a natural dilemma: Does the amount of time to perform the compression outweigh the amount of time spent to transfer the information across the network (i.e., is it more desirable to spend more time compressing in order to spend less time transmitting)? Embodiments of the present invention may provide methods and apparatus automating this decision. Historical evidence, such as throughput capabilities, the amount of time it typically takes to compress a given dataset, and the degree to which the dataset may be compressed may be used in making this decision.

In an embodiment of the present invention, three levels of compression (e.g., low, medium, and high) may be available (in addition to no compression). The high level compression may take much longer than the medium level compression. However, depending upon what data is being compressed (e.g., the content of the dataset), the extra compression may not result in a significant savings. Thus, the high level compression may not be advantageous. Embodiments of the present invention may save flags and extra information on each save (or compression) to keep track of historical compression rates (e.g., the percentage gained), the elapsed time, and CPU usage. This information may be used in future executions. This type of dynamic compression may be configurable by an end user (or system operator). The configurable options may include settings at the systems level, dataset level, and file level. Different options may exist for logical versus physical files (i.e., mandatory files versus supporting structures). Specific files may include specific options. Time to perform a restore, time to perform a save, target goals for compression percentage, etc. may all be configurable options.

Some backup environments may include dedicated GB Ethernet connections, and therefore high throughput rates. Others may be large systems with excess CPU capacity for performing compressions but may include older 100 MB Ethernet networks, and may gain greatly by using higher levels of compression. Embodiments of the present invention may compare historical transfer rates with the effectiveness of different compression levels to determine optimal settings. Some data may be compressed greatly which may result in quicker network transfer times. In some cases though, the CPU cost of this compression or length of time it takes to perform, may render the particular compression an ineffective solution.

Embodiments of the present invention provide methods and apparatus for autonomic compression level selection for backup environments. More specifically, statistics may be gathered during compression of a dataset into a compressed dataset and during transfer of the compressed dataset over a network connection, and compression settings may be optimized based on the gathered statistics.

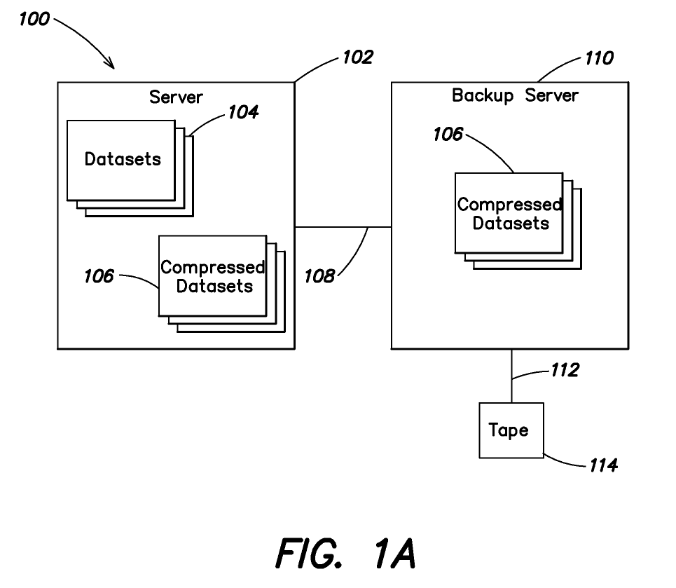

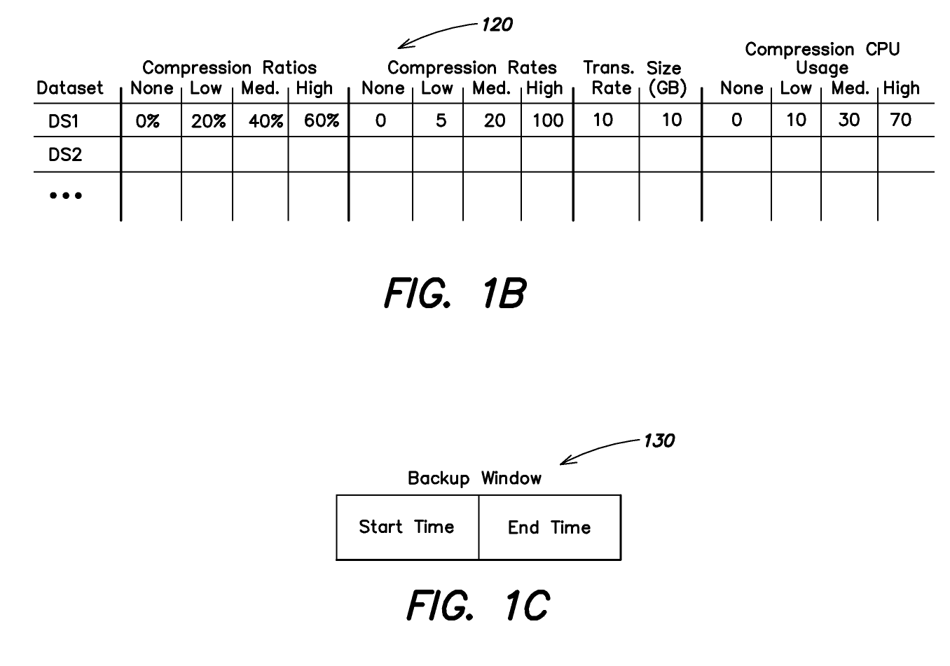

FIG. 1A is a block diagram of an exemplary backup environment 100 in which the present methods and apparatus may be implemented. The backup environment 100 may include a server 102 and a backup server 110. The server 102 and the backup server 110 may be connected via a network connection 108.

The server 102 may include datasets 104. The server 102 may compress the datasets 104 into compressed datasets 106. The compressed datasets 106 may be transmitted over the network connection 108 to the backup server 110.

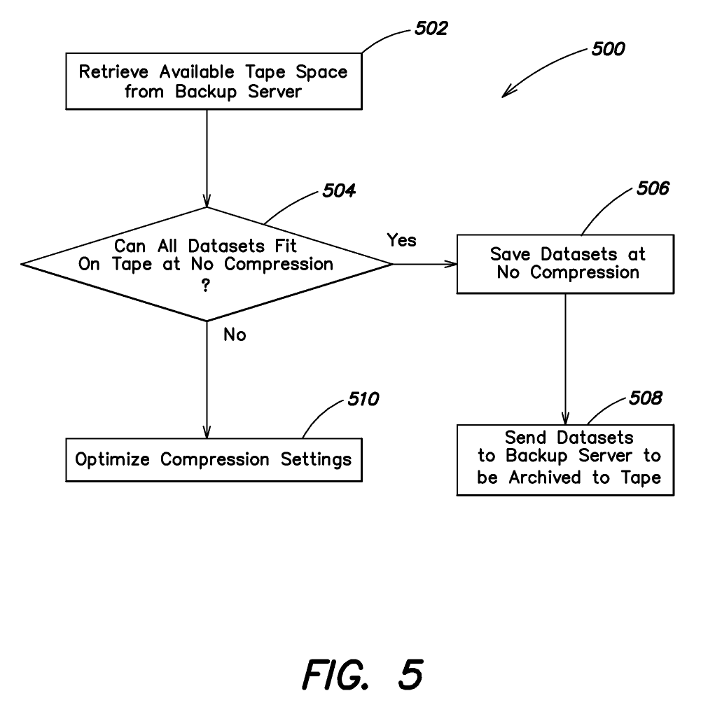

As discussed with respect to FIG. 5, the backup server 110 may, in an embodiment, be connected to a tape storage 114 via a tape connection 112.

FIG. 1B is a schematic representation of exemplary compression ratios, compression rates, transfer rates, sizes, and compression CPU usages for multiple datasets, such as the datasets 104 of FIG. 1A. In an embodiment, the compression ratios, compression rates, and compression CPU usages may correspond to no compression, low compression, medium compression, and high compression.

The compression ratio values may vary for each of the datasets 104. The transfer rate may be a measure of network connection 108 speed. The size may be a measure of the size of a dataset 104.

FIG. 1C is a schematic representation of a backup window 130 for a backup process. The backup window 130 may include a start time and an end time. In an embodiment, the backup window may be, for example, in between normal business hours of a business (e.g., 6 pm to 6 am).

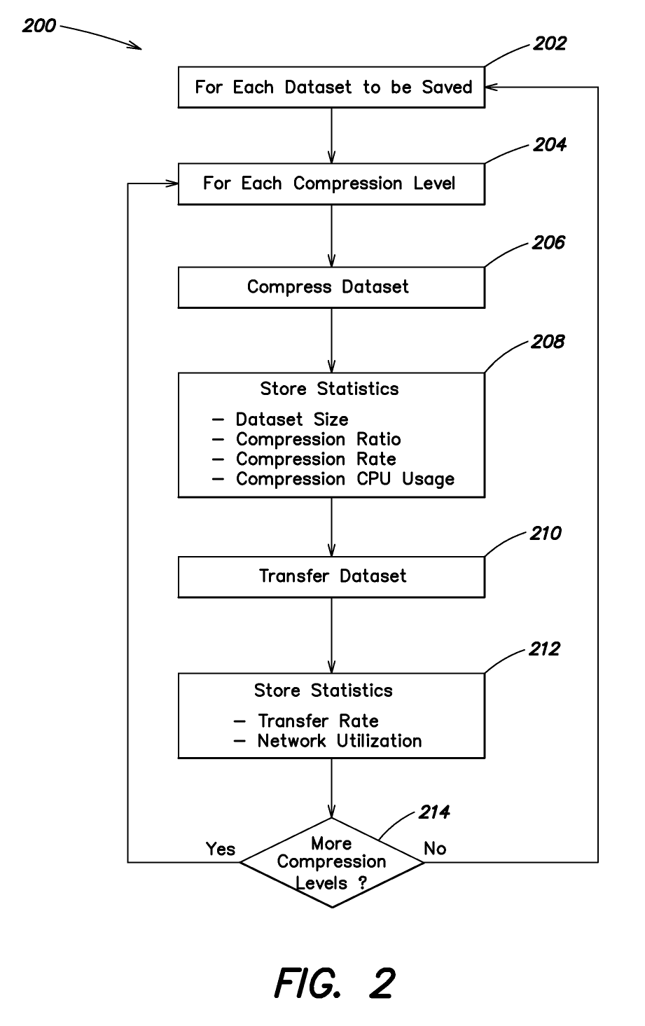

The operation of the backup environment 100 is now described with reference to FIGS. 1A, 1B, and 1C, and with reference to FIGS. 2 through 5. FIG. 2 illustrates an exemplary method 200 for gathering compression ratios, compression rates, transfer rates, sizes, and compression CPU usages for multiple datasets, such as the datasets 104 of FIG. 1A. Operation 202 and subsequent operations may be repeated for each of the datasets 104 to be saved. Operation 204 and subsequent operations may be repeated for each compression level (e.g., low, medium, and high). In operation 206, a dataset 104 may be compressed into a compressed dataset 106. In operation 208, statistics gathered during operation 206 may be stored. The statistics may include a size of the dataset 104, a compression ratio, a compression rate, and a compression CPU usage. In operation 210, the compressed dataset 106 may be transferred from the server 102 to the backup server 110. In operation 212, statistics gathered during operation 210 may be stored. These statistics may include a transfer rate and a network utilization. In operation 214, a determination may be made whether more compression levels remain. If a decision is made that more compression levels remain, operation 204 and subsequent operations may be repeated for the remaining compression levels. If a decision is made that more compression levels do not remain, operation 202 and subsequent operations may be repeated for remaining datasets to be saved.

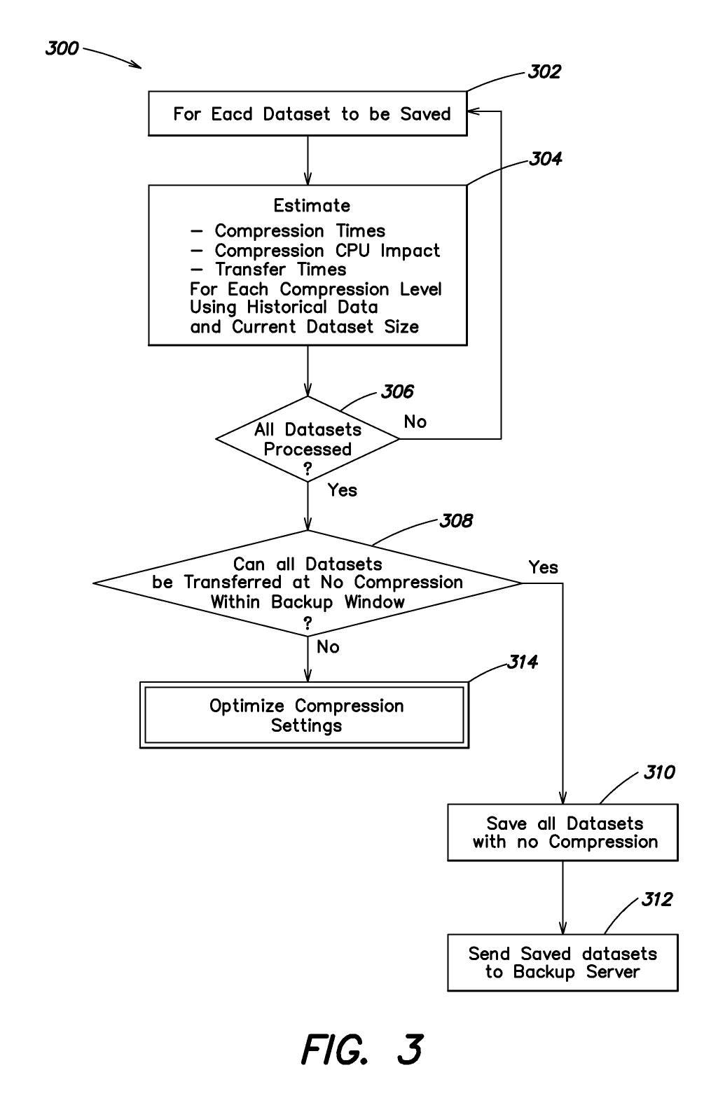

FIG. 3 illustrates an exemplary method 300 for determining whether to compress datasets, such as the datasets 104 of FIG. 1A. Operation 302 and subsequent operations may be repeated for each of the datasets 104 to be saved. In operation 304, compression times, compression CPU impact, and transfer times may be estimated for each compression level using historical data and the size of the current dataset. The historical data may include and/or be calculated based upon stored statistics, such as the statistics stored in an operations 208 and 212 of FIG. 2. Even though the historical data may be accurate, operation 304 may still involve estimation in that datasets 104 in a backup environment may change. In operation 306, a determination may be made whether all of the datasets 104 have been processed. If a decision is made that not all of the datasets 104 have been processed, operation 302 and subsequent operations may be repeated for the remaining datasets 104 to be processed. If a decision is made that all of the datasets 104 have been processed, the method 300 may proceed to operation 308. In operation 308, a determination may be made whether all datasets 104 may be transferred at no compression within a backup window. If a decision is made that all datasets 104 may be transferred at no compression within the backup window, the datasets 104 may be saved with no compression in operation 310, and sent to the backup server 110 in operation 312. Transferring the datasets 104 with no compression may be desirable in that uncompressing datasets may be time-consuming. If a decision is made that not all of the datasets 104 may be transferred at no compression within the backup window, compression settings may be optimized in operation 314.

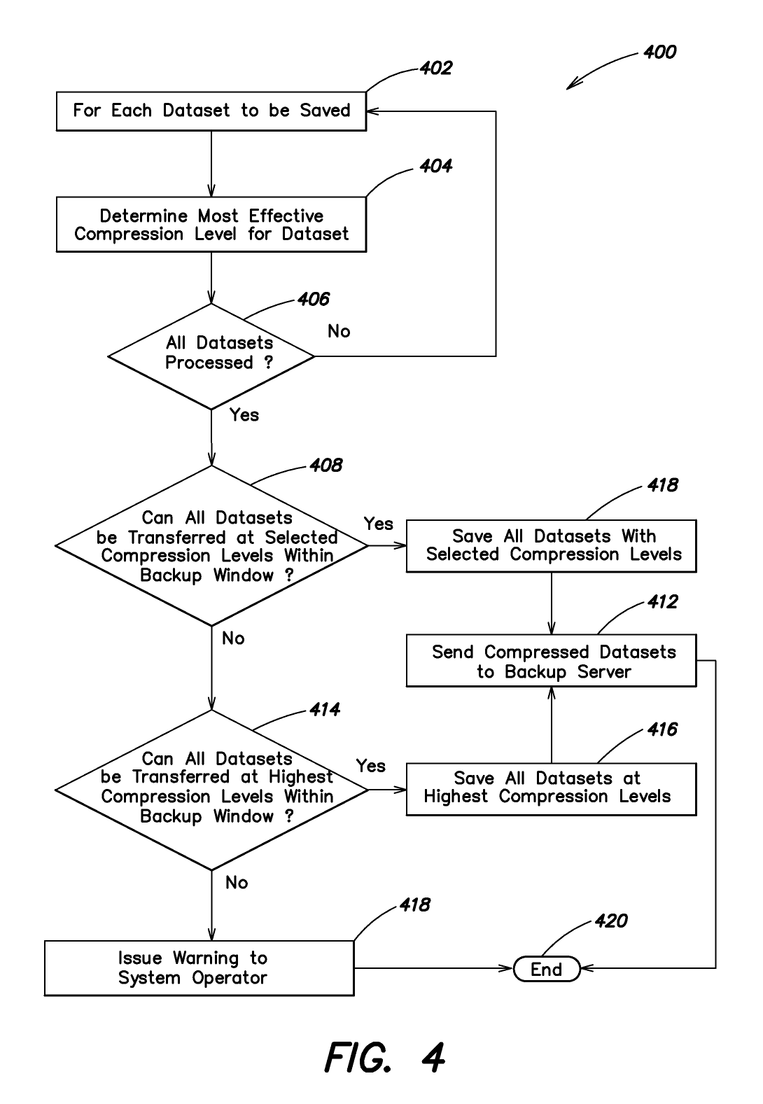

FIG. 4 illustrates an exemplary method 400 of operation 314 of FIG. 3. Operation 402 and subsequent operations may be repeated for each of the datasets 104 to be saved. In operation 404, the most effective compression level for the dataset 104 may be determined. Information such as the information in the schematic representation 120 of FIG. 1B may be used in operation 404. Determination of the most effective compression level may depend on the content of the dataset 104. For example, a dataset containing character data may be compressed very effectively while a dataset containing binary image data may not be compressed as effectively. Operation 404 may balance CPU consumption with compression effectiveness. In operation 406, a determination may be made whether all of the datasets 104 have been processed. If a decision is made that not all of the datasets have been processed, operation 402 and subsequent operations may be repeated for the remaining datasets to be processed. If a decision is made that all of the datasets have been processed, the method 400 may proceed to operation 408. In operation 408, a determination may be made whether all datasets may be transferred at the selected compression levels within the backup window. In operation 408, estimated compression times, compression CPU impact, and transfer times may be taken into account. If a decision is made that all datasets may be transferred at the selected compression levels within the backup window, the datasets may be saved with the selected compression levels in operation 410, the compressed datasets 106 may be sent to the backup server 110 in operation 412, and the method 400 may end 420. If a decision is made that not all datasets may be transferred at the selected compression levels within the backup window, the method 400 may proceed to operation 414. In operation 414, a determination may be made whether all datasets may be transferred at the highest compression levels within the backup window. If a decision is made that all datasets may be transferred at the highest compression levels within the backup window, the datasets may be saved at the highest compression levels in operation 416, the compressed datasets 106 may be sent to the backup server 110 in operation 412, and the method may end 420. If a decision is made that not all datasets may be transferred at the highest compression levels within the backup window, a warning may be issued to the system operator in operation 418, and the method 400 may end 420. Alternatively, if a decision is made that not all datasets may be transferred at the highest compression levels within the backup window, the datasets may be saved with the selected compression levels in operation 410, the compressed datasets 106 may be sent to the backup server 110 in operation 412, and the method 400 may end 420. Alternatively, if a decision is made it not all datasets may be transferred at highest compression levels within the backup window, some datasets (e.g., priority datasets) may be saved at the selected compression levels and sent to the backup server 110.

The methods and apparatus may be applicable with respect to a tape storage. By determining how much space is left on a tape, higher levels of compression may be selected for cases where a dataset and would fit on the tape if compressed at higher levels but would spill over at lower levels. Squeezing onto the end of the tape may be more efficient and cost effective. Such an approach may also be desirable where a user only has a simple tape drive that requires manual exchange of tapes when tapes fill up. FIG. 5 illustrates an exemplary method 500 for determining whether to compress datasets, such as the datasets 104 of FIG. 1A, to be stored on a tape storage 114. In operation 502, available tape space may be retrieved from the backup server 110. In operation 504, a determination may be made whether all datasets 104 may fit on the tape storage 114 at no compression. If a decision is made that all datasets 104 may fit on the tape storage 114 at no compression, the datasets 104 may be saved at no compression in operation 506, and the datasets 104 may be sent to the backup server 110 to be archived to the tape storage in operation 508. If a decision is made that not all datasets 104 may fit on the tape storage at no compression, compression settings may be optimized in operation 510. Operation 510 may include a method similar to method 400 of FIG. 4, though considering available tape space instead of or in addition to a backup window.

The foregoing description discloses only exemplary embodiments of the invention. Modifications of the above-disclosed embodiments of the present invention of which fall within the scope of the invention will be readily apparent to those of ordinary skill in the art. For instance, although the embodiments are described with reference to a server 102 and a backup server 110, the methods and/or apparatus described herein may be applied in other computing devices (e.g., a workstation and a server). Although some embodiments are described with reference to three levels of compression (e.g., low, medium, and high), the methods and/or apparatus described herein may be applied in environments having a different number of levels of compression. Although some embodiments are described with reference to a tape storage 114 and a tape connection 112, the methods and/or apparatus described herein may be applied to other storage devices (e.g., USB storage devices and/or external storage devices). Although some embodiments are described with reference to specific statistics (e.g., dataset size, compression ratio, compression rate, CPU usage), the methods and/or apparatus described herein may be applied using additional and/or alternative statistics.

Accordingly, while the present invention has been disclosed in connection with exemplary embodiments thereof, it should be understood that other embodiments may fall within the spirit and scope of the invention as defined by the following claims.

The invention claimed is:

1. A method, comprising:
gathering statistics during compression of a dataset into a compressed dataset and during transfer of the compressed dataset over a network connection; and
optimizing compression settings based on the gathered statistics.

2. The method of claim 1, wherein the gathering of statistics during compression of the dataset into the compressed dataset comprises gathering at least one of a size of the dataset, a compression ratio, a compression rate, and a compression CPU usage.

3. The method of claim 1, wherein the gathering of statistics during transfer of the compressed dataset over the network connection comprises gathering at least one of a transfer rate and a network utilization.

4. The method of claim 1, wherein the dataset comprises a plurality of datasets and the compressed dataset comprises a plurality of compressed datasets, and wherein the optimizing of compression settings based on the gathered statistics comprises estimating at least one of a compression time, a compression CPU impact, and a transfer time for each of the plurality of datasets at a plurality of compression levels.

5. The method of claim 1, wherein the dataset comprises a plurality of datasets and the compressed dataset comprises a plurality of compressed datasets, and wherein the optimizing of compression settings based on the gathered statistics comprises determining that the plurality of datasets may be transmitted within a backup window each at no compression and transmitting each of the plurality of datasets as the compressed dataset.

6. The method of claim 1, wherein the dataset comprises a plurality of datasets and the compressed dataset comprises a plurality of compressed datasets, and wherein the optimizing of compression settings based on the gathered statistics comprises determining that the plurality of datasets may be transmitted within a backup window each at a most effective compression level.

7. The method of claim 1, wherein the dataset comprises a plurality of datasets and the compressed dataset comprises a plurality of compressed datasets, and wherein the optimizing of compression settings based on the gathered statistics comprises determining that the plurality of datasets may be transmitted within a backup window each at a highest compression level.

8. The method of claim 1, wherein the network connection comprises a tape connection to a tape storage, and wherein the optimizing of the compression settings based on the gathered statistics comprises determining that the dataset may fit on the remaining tape storage at least one of no compression, a most effective compression level, and at a highest compression level.

9. A device, comprising:
a server; and
logic, coupled to the server, and to:
gather statistics during compression of a dataset into a compressed dataset and during transfer of the compressed dataset over a network connection; and
optimize compression settings based on the gathered statistics.

10. The device of claim 9, wherein the logic coupled to the server to gather statistics during compression of the dataset into the compressed dataset comprises logic to gather at least one of a size of the dataset, a compression ratio, a compression rate, and a compression CPU usage.

11. The device of claim 9, wherein the logic coupled to the server to gather statistics during transfer of the compressed dataset over the network connection comprises logic to gather at least one of a transfer rate and a network utilization.

12. The device of claim 9, wherein the dataset comprises a plurality of datasets and the compressed dataset comprises a plurality of compressed datasets, and wherein the logic coupled to the server to optimize compression settings based on the gathered statistics comprises logic to estimate at least one of a compression time, a compression CPU impact, and a transfer time for each of the plurality of datasets at a plurality of compression levels.

13. The device of claim 9, wherein the dataset comprises a plurality of datasets and the compressed dataset comprises a plurality of compressed datasets, and wherein the logic coupled to the server to optimize compression settings based on the gathered statistics comprises logic to determine that the plurality of datasets may be transmitted within a backup window each at no compression and transmitting each of the plurality of datasets as the compressed dataset.

14. The device of claim 9, wherein the dataset comprises a plurality of datasets and the compressed dataset comprises a plurality of compressed datasets, and wherein the logic coupled to the server to optimize compression settings based on the gathered statistics comprises logic to determine that the plurality of datasets may be transmitted within a backup window each at a most effective compression level.

15. The device of claim 9, wherein the dataset comprises a plurality of datasets and the compressed dataset comprises a plurality of compressed datasets, and wherein the logic coupled to the server to optimize compression settings based on the gathered statistics comprises logic to determine that the plurality of datasets may be transmitted within a backup window each at a highest compression level.

16. The device of claim 9, further comprising a tape storage, wherein the network connection comprises a tape connection to the tape storage, and wherein the logic coupled to the server to optimize compression settings based on the gathered statistics comprises logic to determine that the dataset may fit on the remaining tape storage at least one of no compression, a most effective compression level, and at a highest compression level.

17. A system, comprising:
a server;
a backup server; and
logic, coupled to at least one of the server and the backup server, and to:
gather statistics during compression of a dataset into a compressed dataset and during transfer of the compressed dataset over a network connection from the server to the backup server; and
optimize compression settings based on the gathered statistics.

18. The system of claim 17, wherein the logic coupled to at least one of the server and the backup server to gather statistics during compression of the dataset into the compressed dataset comprises logic to gather at least one of a size of the dataset, a compression ratio, a compression rate, and a compression CPU usage.

19. The system of claim 17, wherein the logic coupled to at least one of the server and the backup server to gather statistics during transfer of the compressed dataset over the network connection comprises logic to gather at least one of a transfer rate and a network utilization.

20. The system of claim 17, wherein the dataset comprises a plurality of datasets and the compressed dataset comprises a plurality of compressed datasets, and wherein the logic coupled to at least one of the server and the backup server to optimize compression settings based on the gathered statistics comprises logic to estimate at least one of a compression time, a compression CPU impact, and a transfer time for each of the plurality of datasets at a plurality of compression levels.

21. The system of claim 17, wherein the dataset comprises a plurality of datasets and the compressed dataset comprises a plurality of compressed datasets, and wherein the logic coupled to at least one of the server and the backup server to optimize compression settings based on the gathered statistics comprises logic to determine that the plurality of datasets may be transmitted within a backup window each at no compression and transmitting each of the plurality of datasets as the compressed dataset.

22. The system of claim 17, wherein the dataset comprises a plurality of datasets and the compressed dataset comprises a plurality of compressed datasets, and wherein the logic coupled to at least one of the server and the backup server to optimize compression settings based on the gathered statistics comprises logic to determine that the plurality of datasets may be transmitted within a backup window each at a most effective compression level.

23. The system of claim 17, wherein the dataset comprises a plurality of datasets and the compressed dataset comprises a plurality of compressed datasets, and wherein the logic coupled to at least one of the server and the backup server to optimize compression settings based on the gathered statistics comprises logic to determine that the plurality of datasets may be transmitted within a backup window each at a highest compression level.

24. The system of claim 17, further comprising a tape storage, wherein the network connection comprises a tape connection to the tape storage, and wherein the logic coupled to at least one of the server and the backup server to optimize compression settings based on the gathered statistics comprises logic to determine that the dataset may fit on the remaining tape storage at least one of no compression, a most effective compression level, and at a highest compression level
